(19) United States
(12) Patent Application Publication
(10) Pub. No.: US 2002/0098866 A1
(43) Pub. Date: Jul. 25, 2002

(54) Wireless network telephone set system

(76) Inventor: Wallace Yang, Taichung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/033,967

(22) Filed: Jan. 3, 2002

(30) Foreign Application Priority Data
Jan. 20, 2001 (TW) 090201329

(51) Int. Cl. H04B 1/40

(52) U.S. Cl. 455/557; 455/556; 455/568; 455/575; 455/74; 455/426

(57) ABSTRACT

A wireless network telephone system using an embedded processor as the CPU to provide a portable and expandable network telephone system.

### BACKGROUND OF THE INVENTION

(a) Field of the Invention

The present invention is related to a wireless network telephone system, and more particularly, to one that has an embedded processor as the CPU to provide a portable and expandable network telephone system.

(b) Description of the Prior Art

A network telephone is essentially to transmit, decompose and retrieval voice signals of the conventional telephone in packet under IP protocol to voices that can be recognized by human being. Whereas discussions on basic technology and core value of network telephone have been well documented, only explanation on the background information required to be disclosed under patent law is given herein.

As far as the conventional telephone system is concerned, one telephone line permits only the talk between the calling and the called parties at the same time. The network telephone taking advantage of packet to solve said monopoly allows one line to have data packet waiting on the line in sequence for transmission process and retrieval to improve the general transmission efficiency. As the talk requires no interruption, the voice packet must be given higher priority of transmission. Fast compression and decompression of DSP voice data and the development of high-speed route switch provide the optimal solution.

Applications appearing in Gazette that are similar to the present invention but with different art characteristics include Wireless Telephone Modem Network Telephone & Main Unit Cellular Phone Data Improvement (No. 406912), Methodology and System of Telephone Set with Direct Dial Internet Function without Agent (No. 401546), Computer Network Telephone System (395101), Internet Telephone Switching Hub (No. 378811), and Integrated Service Digital Network Telephone Structure (No. 338591). Within, No. 406912 discloses a phone set that is linked to a computer via a modem to execute selected receiving, use of phone and information transmission; No. 401546, establishment of mutual connection between two phone lines; No. 395101, a server, including a database for storage of calling information of relative terminal, wherein, when the first terminal connected to the server requires the server to be connected to the second terminal which is then breaking off with the server, the server searches and finds out the calling information from the second terminal stored in the database of the second terminal, then uses said calling information from the second terminal to connect the server to the second terminal so to enable the communication between the first and the second terminals; No. 378811 discloses a switching hub that operates with a digital control unit, an analog/digital conversion unit, a compression/decompression unit, a memory unit and a CPU; and No. 338591, a physical composition of a network telephone structure is disclosed.

The prior art as described above generally covers the basic aspects of the entire network telephone technology. However, one or more than one limit or possible defect is found either in the technical approaches or composition: (1) mobility, the prior art relates to a fixed telephone set with wired connection; the connection must be linked to other telephone set if the prior art is to be used elsewhere; (2) convenience, since the prior art must be connected to a telephone set, it is related to a fixed type telephone set and thus can only be used by dialing next to a network telephone set; (3) environmental factor, the prior art can not be used outdoors as it is limited to the general telephone set or that in the office; and (4) expandability, future expansion of the prior art is very limited since it requires wired connection.

### SUMMARY OF THE INVENTION

The primary purpose of the present invention is to provide a wireless network telephone set system that is highly portable and expandable by having an embedded processor as the system process unit.

Other advantages or purposes of the present invention will be described by means of preferred embodiment in conjunction of the accompanying drawings. However, it is to be noted that such embodiment shall not be deemed to limit the teaching of the present invention; any change, substitute or equivalent composition and methodology to the functional structure of the present invention shall be interpreted as the extension of the present invention.

### BRIEF DESCRIPTION OF THE DRAWINGS

FIG. 1(a) is a schematic view showing the process of a network telephone system of the prior art;

FIG. 1(b) is a schematic view showing a flow chart of a preferred embodiment of the present invention;

FIG. 2 is a block diagram of a wireless telephone of the preferred embodiment of the present invention; and

FIG. 3 is a flow chart of the preferred embodiment of the preferred embodiment of the present invention.

### DETAILED DESCRIPTION OF THE PREFERRED EMBODIMENTS

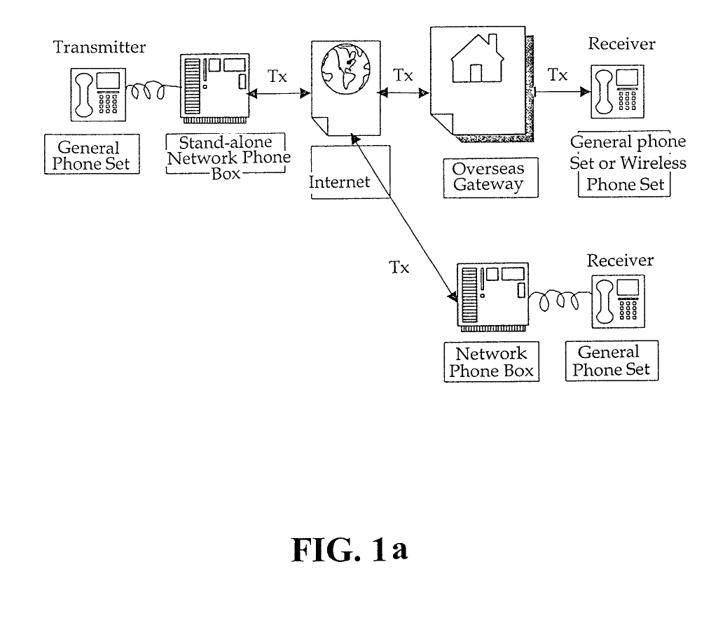

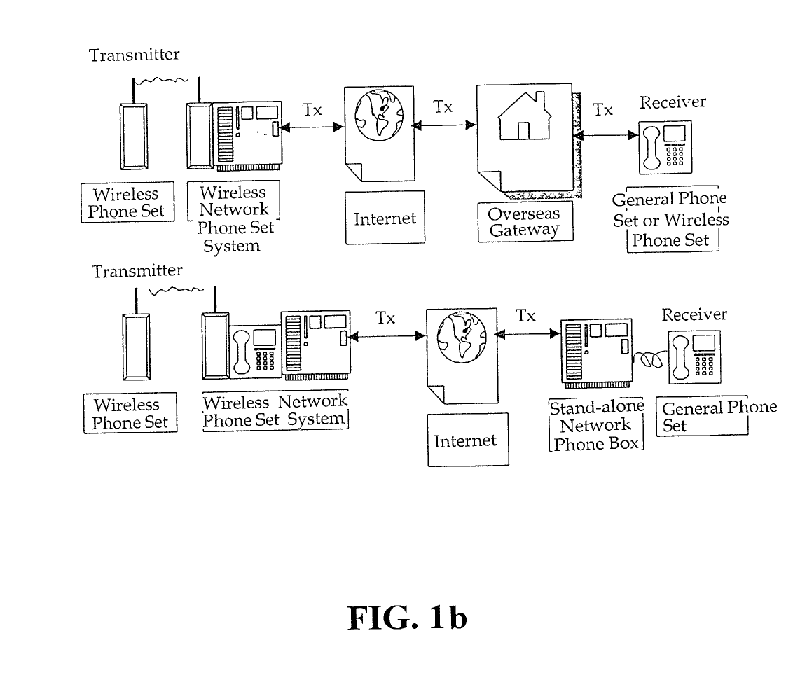

Referring to FIGS. 1(a) and 1(b) for a schematic view of a system flow respectively of the prior art and the present invention, they essentially differ in that the present invention teaches a use of programmable drive type of wireless network telephone set. Network telephone core technology and development of related network telephones have been described above, and supplementary explanations are given for the present invention in terms of improvement or characteristics.

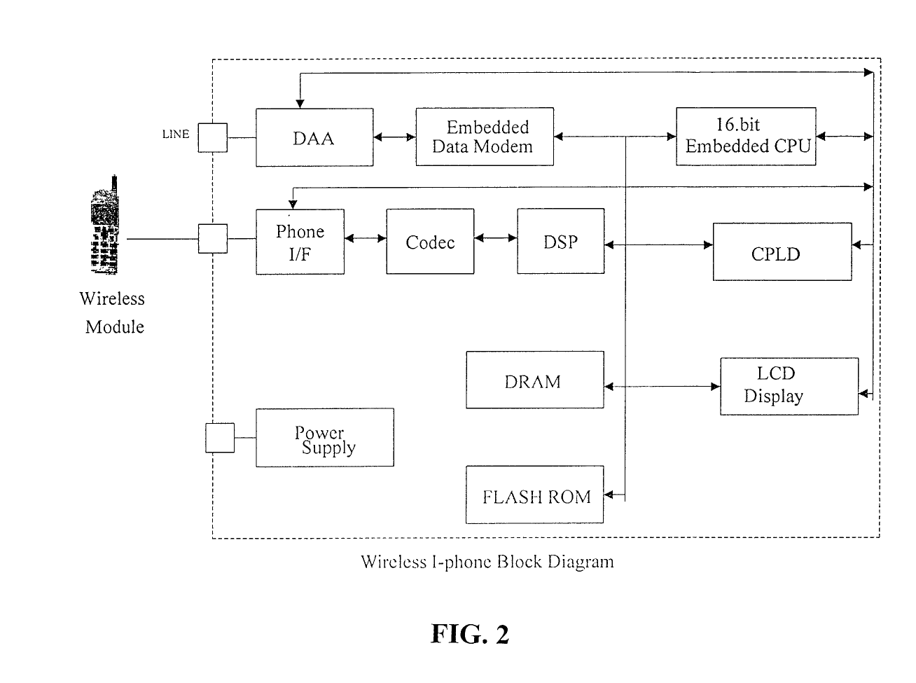

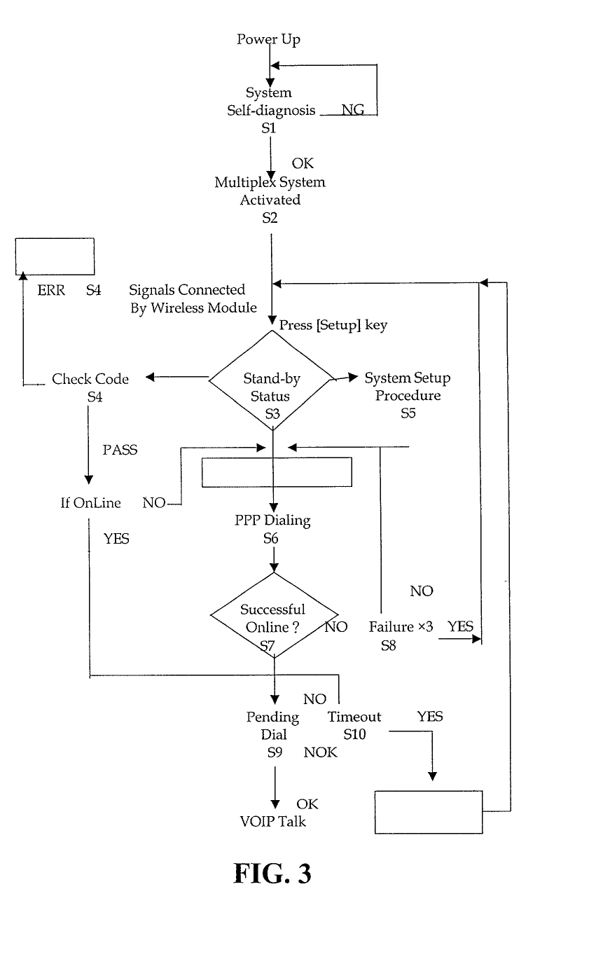

FIGS. 2 and 3 show a preferred embodiment of the present invention essentially comprised of a wireless telephone modulus for two-way voice communication and signal connection with external cellular phone; an analog/digital conversion unit to convert analog signals from the telephone set into digital signals; a compression/decompression unit to receive and compress digital signals outputted from the analog/digital conversion unit, or decompress those compressed digital signals and transmit them to the analog/digital conversion unit; a memory unit to record programming data and register data required, and a CPU to control the process flow among those units.

A built-in wireless telephone module of the present invention is used to activate telecom signals and an embedded CPU (processor) is provided to process and control voice information. FIG. 3 shows the control flow wherein the system enters into S1 self-diagnosis upon power on. If it fails, the system repeats self-diagnosis; if normal, it enters into S2 system activation. Normally, the system will directly enter into S3 stand-by status. Before the system enters into stand-by status, the setup key must be first connected to complete the S4 system setup procedure of pending dial. While the system is in S3 stand-by status, the link between the wireless activation module and the wireless telephone set for the module will detect signals received and enter into S4 wireless module activation when a wireless transmitter is sending signals to a receiver.

The S4 wireless module activation procedure first detects a check code. Once the code is verified, the system further detects whether signals are online. Upon detecting that the signals are successfully online, the module functioning mechanism forthwith enters into S9 pending dial status. If online fails, the transmission end takes over by remote control of online operation through the wireless module. Upon successful connection, the system enters into S6 dialing status. S7 status indicates whether the online function has been successfully activated. Typically, a voice system gives the prompt of “Please Wait”. If it fails after, for example, three continuous attempts, the system will judge whether the result will be Yes or No. If it is Yes, the system will return to S3 stand-by status; when No is judged, the system will move further into S6 before requesting to repeat S5. Upon being successfully online, the system sounds off signals, such as ‘Doo-Doo-Doo’ to call a cellular phone in the transmission area. If it fails, the system enters into S10 for dial timing of automatic offline mechanism, and further into S11 for judging the automatic offline mechanism.

When the system gives an audible prompt of being successful online, the system directly enters into S9 pending dial status. If the pending dial mechanism is idle for a period such as three minutes, the system automatically detects the idling status and enters into S10 for the judgment of Yes before entering into S11 automatic offline.

Furthermore, upon completing the dialing, the system verifies the dial then proceeds to normal talk status and enters into normal talk by voice.

The present invention by having the wireless module as the system interface and the embedded CPU for flow process and control is generally applicable to wireless walkie-talkie, wireless telephone set, programmable wireless RC walkie-talkie, IR digital RC audio controller and cellular phones. The art of incorporating software programming with hardware interface of the present invention provides at least the following advantages:

1. The main unit relates to a fixed telephone set with wired link to provide excellent mobility and does not require to move the main unit to connect to another telephone set if the present invention is operating at another location;

2. The present invention offers more convenient operation by permitting connection to an indoor stationary network by dialing from a cellular phone; and

3. The present invention promises future expansion due to development of new devices since the interface module for transmission of audio signals is applicable to execute wireless transmission.

As disclosed above, the present invention meets the requirements of a utility patent by providing creative functions while effectively solving potential defects found with the prior art under application. Therefore, this application is duly filed accordingly.

I claim:

1. A wireless network telephone system comprised of:
a wireless telephone module for two-way voice communication with external cellular phone;
an analog/digital conversion unit to convert voice analog signals into digital signals or to convert digital signals received into analog signals;
a compression/decompression unit to receive and compress digital signals outputted from the analog/digital conversion unit, or to decompress and transmit compressed signals to the analog/digital conversion unit;
a memory to register programming and temporary data and a CPU, to control operating flow among those units;
characterized by that telecommunication signals being activated by the wireless telephone module for the embedded CPU to process and control voice information.

2. A wireless network telephone system as claimed in claim 1, wherein, voice information process and control between the wireless network module and the CPU includes:
code checking procedure to ensure legitimate right of use of the operator; and
online connection determination procedure, so that upon successful connection, modular functions to directly enter into network dial pending procedure for input of telephone number of the receiver, or before signals entering into network connection function, the transmission end being able to directly remote control connection to network via the wireless module.
